(19) United States
(12) Patent Application Publication
(10) Pub. No.: US 2015/0348113 A1
(43) Pub. Date: Dec. 3, 2015

(54) METHOD AND SYSTEM FOR DERIVING A STORY ON A STORY BOARD ON MOBILE COMMUNICATION DEVICE'S LOCK SCREEN

(71) Applicant: Jian Wei Tam, New York, NY (US)

(72) Inventor: Jian Wei Tam, New York, NY (US)

(21) Appl. No.: 14/294,153

(22) Filed: Jun. 3, 2014

(51) Int. Cl. G06Q 30/02; H04W 4/20; H04W 4/12

(52) U.S. Cl. CPC G06Q 30/0267; H04W 4/12; H04W 4/206

(57) ABSTRACT

A method and system for deriving a story on a story board on mobile communication device's lock screen. Particularly, the application provides a method and system for deriving a story on a story board on mobile communication device's lock screen by a user, characterized by deriving said story on said story board by cumulating a plurality of visual segments of information pertaining to said story.

### FIELD OF THE INVENTION

The present application generally relates to the field of mobile applications. Particularly, the application provides a method and system for deriving a story on a story board on mobile communication device's lock screen by a user, More particularly, the application provides a method and system for deriving a story on a story board by cumulating a plurality of visual segments of information pertaining to said story.

### BACKGROUND

Mobile communication devices enable users to communicate each other while the devices are in unlocked mode. On the other hand, every mobile communication device has a lock screen, which provides with the user ability to communicate visually on the locked space. There are various applications which have been designed and implemented for the mobile communication device's lock screen, wherein the users may always stay up to date on their network and personal interests.

Prior art literature illustrates a variety of mobile application for lock screen of mobile communication devices including digital content sharing and advertising etc. However, the lock screen space of the mobile communication device doesn't come with a virtual story board, wherein a user is allowed to collect various segments of a story pushed to user by a product or service merchandise on its mobile communication device's lock screen for deriving a particular story.

Thus, in the light of the above mentioned background art, it is evident that, there is a need for a method and system for deriving a story on a story board on mobile communication device's lock screen by a user. There is also a need for a method and system for deriving a story on a story board by cumulating a plurality of visual segments of information pertaining to said story.

### SUMMARY

Before the present systems and methods, enablement are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application.

In accordance with the present application, the primary objective is to provide a method and system for deriving a story on a story board on mobile communication device's lock screen by a user, Particularly, the application provides a method and system for deriving a story on a story board by cumulating a plurality of visual segments of information pertaining to said story.

In an embodiment of the present invention, a method and system is provided for pushing, a plurality of visual segments of information pertaining to a story on a story board on a user's mobile communication device's lock screen by a merchandise; visualizing and collecting said pushed plurality of visual segments of information pertaining to said story on the story board on mobile communication device's lock screen by the user; and completing and deriving the story on the story board on mobile communication device's lock screen by cumulating all visual segments of information pertaining to said particular story pushed on the story board on mobile communication device's lock screen by the user.

The above mentioned method and system is provided for deriving a story on a story board by cumulating a plurality of visual segments of information pertaining to said story but also can be used for many other applications.

### BRIEF DESCRIPTION OF THE DRAWINGS

The foregoing summary, as well as the following detailed description of preferred embodiments, is better understood when read in conjunction with the appended drawings. There is shown in the drawings example embodiments, however, the application is not limited to the specific system and method disclosed in the drawings.

FIG. 1: shows a flow chart illustrating method for deriving a story on a story board on mobile communication device's lock screen.

FIG. 2: shows a flow chart illustrating method for deriving a story of food outlet by a user on a story board on mobile communication device's lock screen.

FIG. 3: shows a flow chart illustrating method for deriving a story of a comic book by a user on a story board on mobile communication device's lock screen.

### DETAILED DESCRIPTION

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

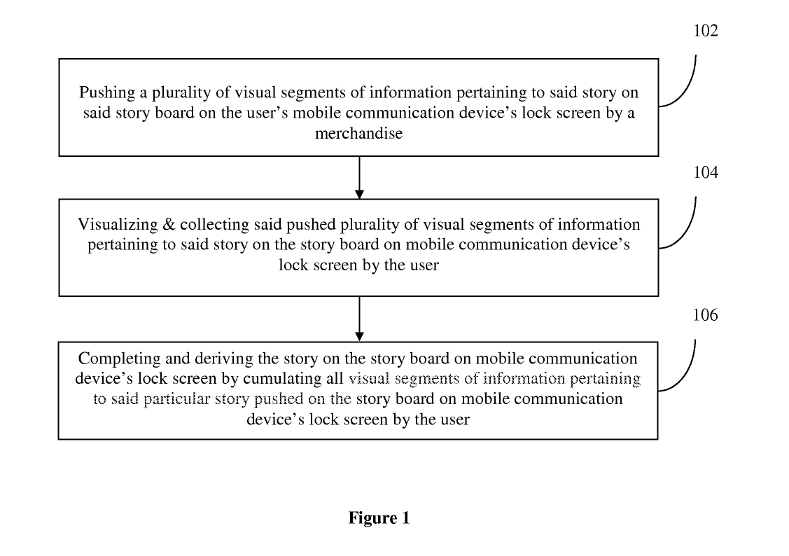

Referring to FIG. 1 is a flow chart illustrating method for deriving a story on a story board on mobile communication device's lock screen.

The present invention provides a method and system for deriving a story on a story board on mobile communication device's lock screen by a user, characterized by deriving said story on said story board by cumulating a plurality of visual segments of information pertaining to said story; by employing a mobile lock screen application residing in a mobile communication device for story board for performing following steps. The mobile communication device is selected from a group comprising but not limited to mobile phone, laptop, and PDA.

The process starts at the step 102, a plurality of visual segments of information pertaining to said story is pushed on said story board on the user's mobile communication device's lock screen by a merchandise.

In an embodiment of the present invention, the visual segments of information pertaining to a particular story is selected from a group comprising of but not limited to wallpaper, advertisement, picture, audio, and video. The plurality of visual segments of information pertaining to said story is pushed on the story board of lock screen of the user's mobile communication device by the merchandise. The merchandise pushing a plurality of visual segments of information pertaining to said story on said story board on the user's mobile communication device's lock screen is selected from a group comprising of a product merchandise and a service merchandise. The plurality of visual segments of information pertaining to said story is pushed on the story board of lock screen of the user's mobile communication device by the merchandise based on the user's mobile communication devices proximity with said merchandise.

At the step 104, said pushed plurality of visual segments of information pertaining to said story are visualized and collected on the story board on mobile communication device's lock screen by the user.

The process ends at the step 106, the story is completed and derived by cumulating all visual segments of information pertaining to said particular story pushed on the story board on mobile communication device's lock screen by the user.

In another embodiment of the present invention, upon deriving said story on said story board on mobile communication device's lock screen by cumulating the plurality of visual segments of information pertaining to said story; the user may be rewarded, wherein the reward system may be designed and implemented by the product or the service merchandise.

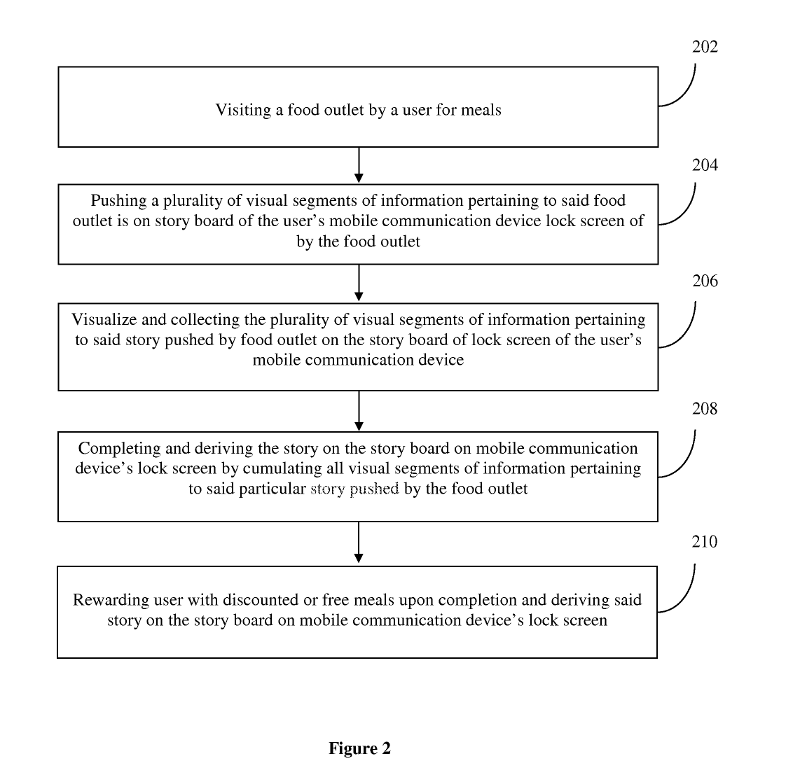

Referring to FIG. 2 is a flow chart illustrating method for deriving a story of food outlet by a user on a story board on mobile communication device's lock screen.

In an exemplary embodiment of the present invention, method for deriving a story of food outlet by a user on a story board on mobile communication device's lock screen is illustrated.

The process starts at the step 202, a food outlet such as McDonalds is visited by a user for meals.

At the step 204, a plurality of visual segments of information pertaining to said food outlet is pushed on story board of the user's mobile communication device lock screen of by the food outlet McDonald. The visual segments of information pertaining to said story is selected from a group comprising of but not limited to wallpaper, advertisement, picture, audio, and video pertaining to McDonalds.

At the step 206, the plurality of visual segments of information pertaining to said story is visualized and collected by the user, which is pushed by McDonald on the story board of lock screen of the user's mobile communication device. When user visits same outlet of McDonalds multiple times or various other McDonalds stores, after receiving and collecting all visual segments of information pertaining to said story on the story board of lock screen of the user's mobile communication the story gets completed.

At the step 208, the story is completed and derived by the user on the story board on mobile communication device's lock screen by cumulating all visual segments of information pertaining to said particular story pushed on the story board on mobile communication device's lock screen by food outlet McDonalds.

The process ends at the step 210, the user may be rewarded by food outlet such as McDonalds upon completion and deriving said story by way of discounted or free meals for completing said story on the story board.

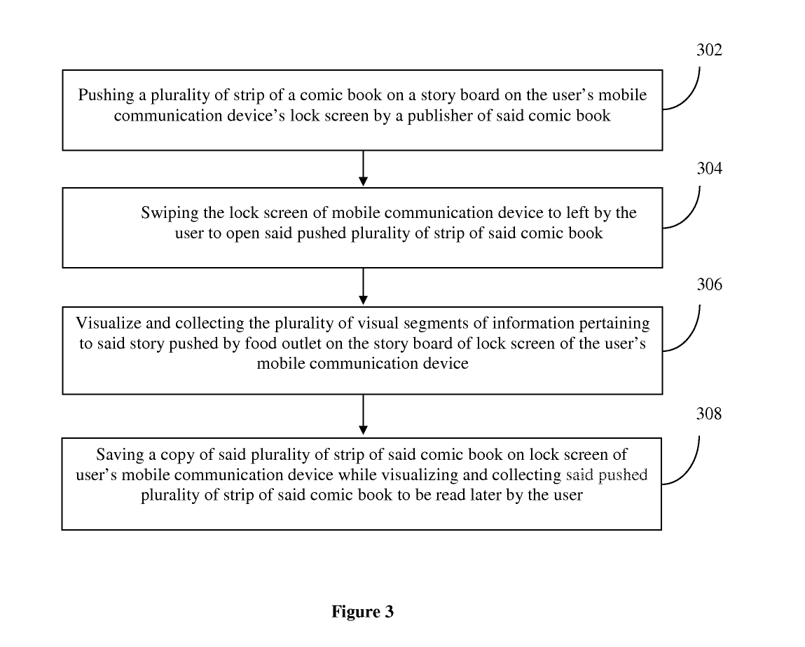

Referring to FIG. 3 is a flow chart illustrating method for deriving a story of a comic book by a user on a story board on mobile communication device's lock screen.

In an exemplary embodiment of the present invention, a plurality of visual segments of information pertaining to a story such as a comic book is illustrated.

The process starts at the step 302, a plurality of visual segments of information pertaining to a story such as a comic book is pushed on a story board on the user's mobile communication device's lock screen by the merchandise, company or publisher of said comic book. The plurality of visual segments of information pertaining to said comic book is in the form of a plurality of strip of said comic book.

At the step 304, the lock screen of mobile communication device is swiped to left by the user to open said pushed plurality of strip of said comic book.

At the step 306, the user is enabled to visualize and collect said pushed plurality of strip of said comic book on the story board on mobile communication device's lock screen.

The process ends at the step 308, a copy of said plurality of strip of said comic book is saved on lock screen of user's mobile communication device to be read later by the user, while visualizing and collecting said pushed plurality of strip of said comic book on the story board on mobile communication device's lock screen.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

The preceding description has been presented with reference to various embodiments. Persons skilled in the art and technology to which this application pertains will appreciate that alterations and changes in the described structures and methods of operation can be practiced without meaningfully departing from the principle, spirit and scope.

We claim:

1. A method for deriving a story on a story board on mobile communication device's lock screen by a user, characterized by deriving said story on said story board by cumulating a plurality of visual segments of information pertaining to said story; said method comprises of:
a. pushing a plurality of visual segments of information pertaining to said story on said story board on the user's mobile communication device's lock screen by a merchandise;
b. visualizing and collecting said pushed plurality of visual segments of information pertaining to said story on the story board on mobile communication device's lock screen by the user; and
c. completing and deriving the story on the story board on mobile communication device's lock screen by cumulating all visual segments of information pertaining to said particular story pushed on the story board on mobile communication device's lock screen by the user.

2. The method as claimed in claim 1, wherein the visual segments of information pertaining to the particular story is selected from a group comprising of wallpaper, advertisement, picture, audio, and video.

3. The method as claimed in claim 1, wherein said merchandise pushing a plurality of visual segments of information pertaining to said story on said story board on the user's mobile communication device's lock screen is selected from a group comprising of a product merchandise and a service merchandise.

4. The method as claimed in claim 1, wherein the plurality of visual segments of information pertaining to said story is pushed on the story board of lock screen of the user's mobile communication device by the merchandise based on the user's mobile communication devices proximity with said merchandise.

5. The method as claimed in claim 1, wherein further comprise of rewarding the user with redeemable reward points for deriving said story on said story board on mobile communication device lock screen by cumulating the plurality of visual segments of information pertaining to said story.

6. The method as claimed in claim 1, wherein further comprise of saving a copy of said derived story comprising of cumulated plurality of visual segments of information pertaining to said story on user's mobile communication device.

7. A system for deriving a story on a story board on mobile communication device's lock screen by a user, characterized by deriving said story on said story board by cumulating a plurality of visual segments of information pertaining to said story; said system comprises of a mobile lock screen application residing in a mobile communication device for story board;
a. adapted for receiving a plurality of visual segments of information pertaining to said story pushed on said story board on the user's mobile communication device's lock screen by a merchandise;
b. enabling the user to visualizing and collecting said pushed plurality of visual segments of information pertaining to said story on the story board on mobile communication device's lock screen; and
c. adapted for completing and deriving the story on the story board on mobile communication device's lock screen by cumulating all visual segments of information pertaining to said particular story pushed on the story board on mobile communication device's lock screen by the user.

8. The system as claimed in claim 6, wherein the mobile communication device is selected from a group comprising but not limited to mobile phone, laptop, and PDA.
